(19) United States
(12) Patent Application Publication
(10) Pub. No.: US 2026/0246332 A1
(43) Pub. Date: Aug. 20, 2026

(54) ELECTRIC DRIVE UNIT WITH FLUID JACKET

(71) Applicant: Schaeffler Technologies AG & Co. KG, Herzogenaurach (DE)

(72) Inventors: David Puma Benavides, Puebla (MX); Pedro Angel Hernandez, Irapuato (MX); Antonio Cortes, Puebla (MX)

(73) Assignee: Schaeffler Technologies AG & Co. KG, Herzogenaurach (DE)

(21) Appl. No.: 19/055,220

(22) Filed: Feb. 17, 2025

(51) Int. Cl. H02K 5/20

(52) U.S. Cl. CPC H02K 5/20

(57) ABSTRACT

An electric drive unit includes a housing that includes an outer wall. A stator carrier is disposed radially inboard of the outer wall defining a space therebetween. At least one rib contacts the stator carrier and forms a pair of passages. The at least one rib defines at least one opening forming a fluid path between the pair of passages.

### FIELD OF THE DISCLOSURE

The present disclosure generally relates to electric drive units. More specifically, the present disclosure relates to fluid jackets for electric drive units.

### BACKGROUND OF THE DISCLOSURE

Electric drive units can include fluid jackets in various implementations.

### SUMMARY OF THE DISCLOSURE

According to a first aspect of the present disclosure, an electric drive unit includes a housing that includes an outer wall. A stator carrier is disposed radially inboard of the outer wall defining a space therebetween. At least one rib contacts the stator carrier and forms a pair of passages. The at least one rib defines at least one opening forming a path between the pair of passages.

Embodiments of the first aspect of the disclosure can include any one or a combination of the following features:
the at least one opening includes a plurality of openings, each forming a recessed portion of the at least one rib, wherein the recessed portions of the at least one rib are spaced apart by raised portions of the at least one rib that extend radially outboard relative to the recessed portions;
the at least one rib includes a first rib and a second rib axially spaced from the first rib to form an intermediate passage therebetween;
a recessed portion of the first rib is circumferentially aligned with a first raised portion of the second rib;
a spine coupled with the first rib and the second rib and extending axially in the space to further define the pair of passages and the intermediate passage;
each of the first rib and the second rib includes a body extending between a first end coupled with the spine and a second end coupled with the spine;
the first rib includes a second raised portion extending from the first end of the first rib, and wherein the first raised portion extends from the first end of the second rib further than the second raised portion extends from the first end of the first rib;
a spine contacting the stator carrier and coupled to the at least one rib, wherein the at least one rib includes a first rib and a second rib axially spaced from the first rib, the at least one opening includes one or more first openings defined by the first rib, the one or more first openings comprises a first opening that is a nearest one of the one or more first openings to the spine in a first circumferential direction, the at least one opening includes one or more second openings defined by the second rib, the one or more second openings comprises a second opening that is a nearest one of the one or more second openings to the spine in the first circumferential direction, and the first opening is circumferentially offset from the second opening.
the stator carrier defines an axial groove extending radially inwardly in which the at least one rib is disposed;
a fluid inlet that conveys fluid into a first passage of the pair of passages; and a fluid outlet that conveys fluid out of a second passage of the pair of passages; and
the at least one rib is not unitary with the stator carrier.

According to a second aspect of the present disclosure, an electric drive unit includes a housing that includes an outer wall and a stator carrier disposed radially inboard of the outer wall defining a space therebetween. A first rib contacts the stator carrier and extends circumferentially therearound. The first rib includes a first raised portion and defines a first opening and a second opening spaced circumferentially from the first opening by the first raised portion. A second rib contacts the stator carrier and extends circumferentially therearound. The second rib is axially spaced from the first rib to define a passage therebetween. The second rib includes a second raised portion and defines a third opening at least partially formed by the second raised portion. The first opening is circumferentially aligned with the second raised portion, and the second opening is circumferentially aligned with the third opening.

Embodiments of the second aspect of the disclosure can include any one or a combination of the following features:
a spine coupled with the first rib and the second rib and extending axially in the space to further define the passage;
each of the first rib and the second rib includes a body extending between a first end coupled with the spine and a second end coupled with the spine;
the stator carrier defines a circumferential groove in which the first rib and the second rib are disposed;
the spine is configured to circumferentially retain the ribs relative to the stator carrier; and
the spine is configured to axially retain the ribs relative to the stator carrier.

According to a third aspect of the present disclosure, an electric drive unit includes a housing that includes an outer wall, a stator carrier disposed radially inboard of the outer wall defining a space therebetween, and a spine extending axially in the space. The electric drive unit includes a first rib that extends from the spine and that defines a first plurality of openings that are circumferentially offset from each other. The first plurality of openings includes a first opening that is a nearest opening of the first plurality of openings to the spine in a first circumferential direction. The electric drive unit includes a second rib that extends from the spine and that defines a second plurality of openings that are circumferentially offset from each other. The second plurality of openings includes a second opening that is a nearest opening of the second plurality of openings to the spine in the first circumferential direction. The first opening is circumferentially offset from the second opening. The first opening is nearer to the spine than the second opening is to the spine. The second opening is aligned with one of the first plurality of openings nearest to the first opening in the first circumferential direction.

Embodiments of the third aspect of the disclosure can include any one or a combination of the following features:
the second opening is circumferentially aligned with the one opening of the first plurality of openings nearest to the first opening in the first circumferential direction; and
the first plurality of openings includes all of the openings defined by the first rib, and the second plurality of openings includes all of the openings defined by the second rib.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of an electric drive unit;

FIG. 2 is a side elevational view of an electric drive unit;

FIG. 3 is a cross-sectional view of the electric drive unit of FIG. 2 taken at line III-III, illustrating a space defined by a housing and a stator carrier;

FIG. 4 is a perspective view of a stator carrier;

FIG. 5 is a perspective view of a stator carrier with a guide system disposed around a barrel of the stator carrier; and

FIG. 6 is a detailed perspective view of a portion of the guide system of FIG. 5 with the barrel omitted.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along an axis of rotation about which one or more components are configured to rotate in operation of the apparatus described herein. Further, the term “radial” and derivatives thereof, such as “radially,” shall be understood in relation to the axis. For example, “radially outboard” refers to further away from the axis, while “radially inboard” refers to nearer to the axis. The term “circumferential” and derivatives thereof, such as “circumferentially,” shall be understood in relation to the axis. These terms shall be understood in relation to the axis about which one or more components are configured to rotate in operation of the apparatus even as the terms are applied to components of the apparatus that are not configured to rotate about the axis in operation of the apparatus. For example, the terms, “axial,” “radial,” “circumferential,” and derivates thereof shall be understood in relation to an axis about which a rotor shaft of an electric drive unit is configured rotate, but can be used herein in relation to, for example, a stator carrier of the electric drive unit that is not configured to rotate about the axis.

As used herein, “non-rotatably connected” elements shall be understood to refer to elements that are connected such that whenever one of the elements rotates about the axis, all of the elements rotate about the axis at a common rate of rotation, and relative rotation between the elements is restricted.

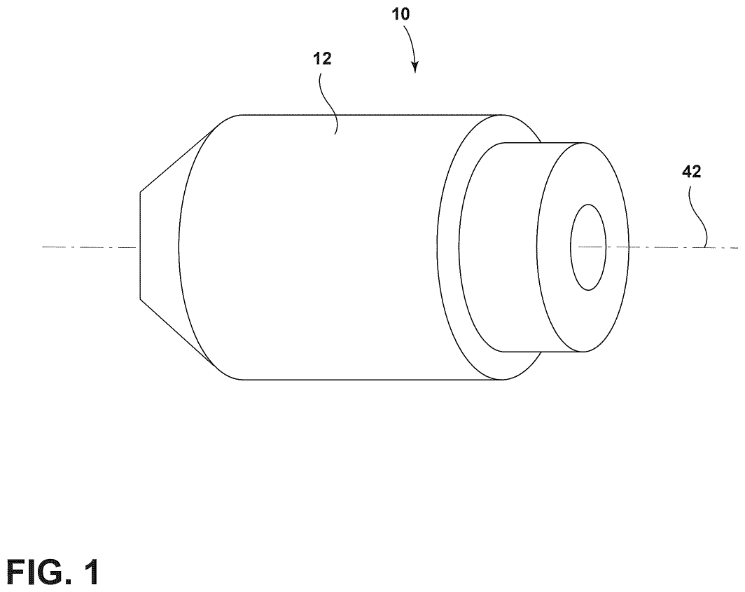

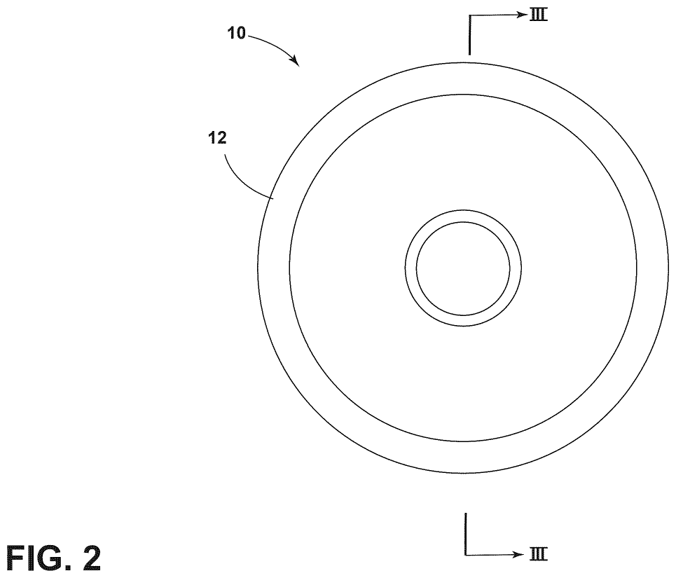

Referring now to FIGS. 1-6, an electric drive unit 10 includes a housing 12. The housing 12 includes an outer wall 14. A stator carrier 16 is disposed radially inboard of the outer wall defining a space 18 therebetween. At least one rib 20a-20e contacts the stator carrier 16 and forms a pair of passages 22a-22b. The at least one rib 20a-20e defines at least one opening 24a-24z forming a path between the pair of passages 22a-22b.

Referring now to FIGS. 1-3, the electric drive unit 10 includes the housing 12. The housing 12 can include a bearing shield 28 that extends radially inboard from the outer wall 14. A stator 30 is disposed within the housing 12 radially inboard of the outer wall 14 and in an axially-spaced relationship with the bearing shield 28. The stator carrier 16 includes a barrel 32 that can have a substantially cylindrical shape. The barrel 32 is positioned radially between the stator 30 and the outer wall 14 and extends along the stator 30.

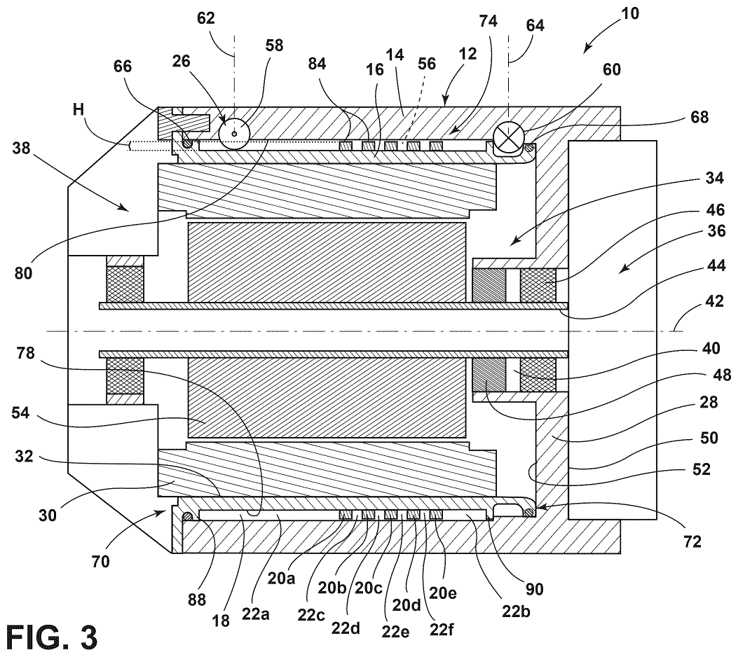

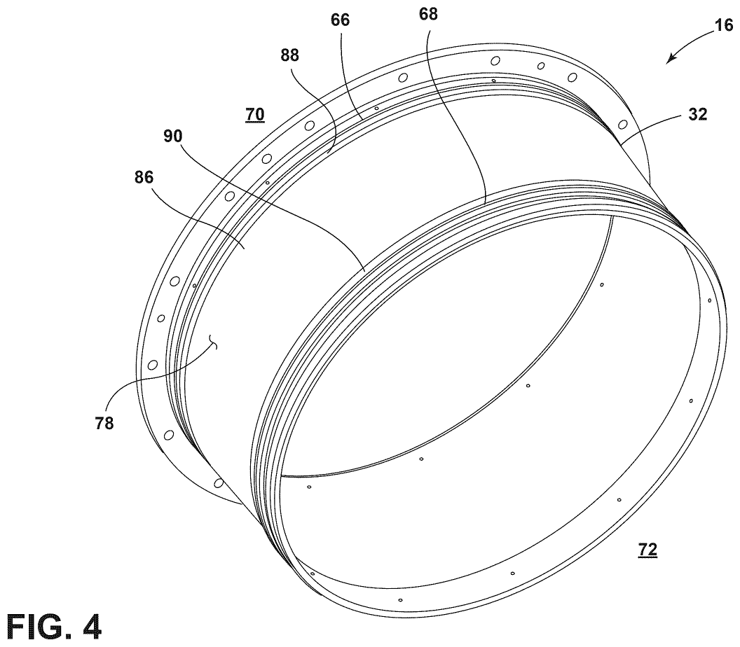

The housing 12 can be an assembly of a plurality of components, in some examples. For example, the housing 12 can be a die-cast aluminum housing 12 that is formed of a plurality of components. The housing 12 can define a motor housing region 34 and a gearbox region 36. A motor 38 of the electric drive unit 10 can be housed within the motor housing region 34. The gearbox region 36 defined by the housing 12 can contain a plurality of electric drive unit components, such as a gearset and a differential (not shown). Further, the gearbox region 36 may serve as a reservoir for oil. The housing 12 includes the outer wall 14 that has an inner surface and an outer surface. The outer wall 14 can extend generally circumferentially about the motor 38 of the electric drive unit 10. The housing 12 further includes the bearing shield 28. The bearing shield 28 extends radially inboard from the outer wall 14 and is arranged to separate the oil cavity of the gearbox region 36 from the dry cavity of the motor housing region 34. As illustrated in FIG. 3, the bearing shield 28 can define a central aperture 40. An axis 42 about which a rotor shaft 44 of the motor 38 is configured to rotate, as described further herein, may extend through the central aperture 40 in various embodiments. A bearing 46 can be positioned radially between the bearing shield 28 and the rotor shaft 44 of the motor 38, as illustrated in FIG. 3. The bearing 46 can support and facilitate rotation of the rotor shaft 44 about the axis 42. A dynamic seal 48 may be arranged between the bearing shield 28 and the rotor shaft 44 to prevent or block oil from entering the motor housing region 34. As illustrated in FIG. 4, the bearing shield 28 includes a first surface 50 that faces the motor housing region 34 and a second surface 52 opposite the first surface 50 that defines the gearbox region 36 of the housing 12.

Referring now to FIG. 3, the electric drive unit 10 includes the motor 38. The motor 38 includes the stator 30, a rotor 54, and the rotor shaft 44. In an exemplary embodiment, operation of the motor 38 drives rotation of the rotor shaft 44 about the axis 42, which may drive first and second output shafts (not shown) that are operably coupled to the rotor 54 via a gearset and differential (not shown) disposed within the gearbox region 36 defined by the housing 12. A variety of types of electric motors 38 are contemplated for use in the electric drive unit 10. For example, the motor 38 can be an induction motor. As illustrated in FIG. 4, the rotor shaft 44 is positioned radially inboard of the rotor 54 and stator 30 and extends axially through the rotor 54 of the motor 38. Further, the stator 30 is disposed within the housing 12 radially inboard of the outer wall 14 of the housing 12, and the stator 30 is in an axially-spaced relationship with the bearing shield 28 of the housing 12.

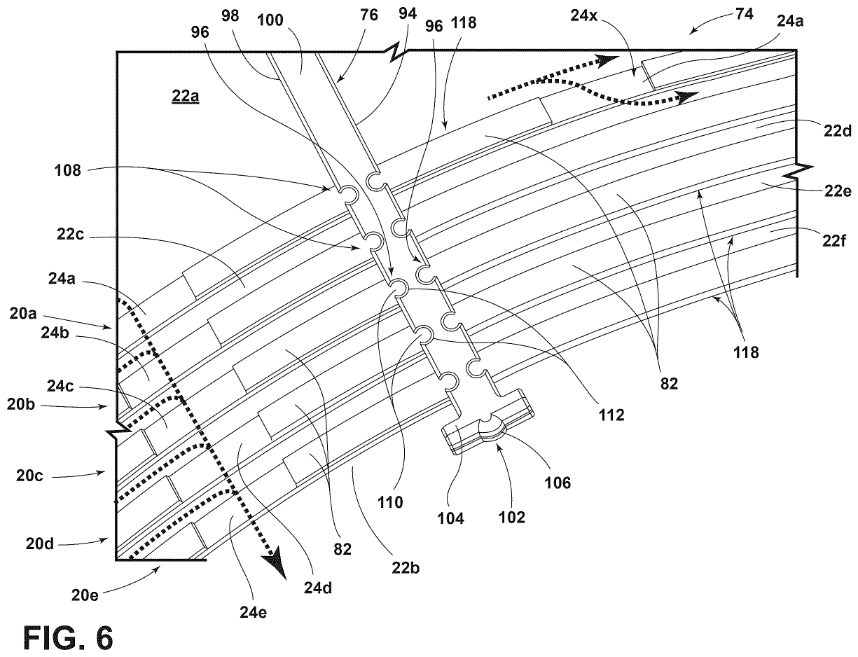

With continued reference to FIG. 3, the stator carrier 16 is operably coupled with the stator 30. In one embodiment, the stator 30 can be coupled to an inner surface of the stator carrier 16 via a shrink fit arrangement; however, other methods can be utilized, in various implementations. The stator carrier 16 can include the barrel 32. As illustrated in FIG. 4, the barrel 32 of the stator carrier 16 is positioned radially between the stator 30 and the outer wall 14 and extends along the stator 30. The stator carrier 16 and the housing 12 define the space 18. In various embodiments, the stator carrier 16 and the inner surface of the outer wall 14 of the housing 12 define the space 18. The space 18 is configured to convey fluid 56 for removal of heat from the electric drive unit 10, such as from the motor 34. In various embodiments, a fluid circuit 26, at least partially illustrated in FIG. 6, through which fluid 56 is cyclically circulated is provided in the space 18. In the embodiment illustrated in FIG. 3, the electric drive unit 10 includes a fluid inlet 58 that conveys fluid 56 into the space 18 at a first axial position 62 and a fluid outlet 60 that conveys fluid 56 out of the space 18 at a second axial position 64. The fluid inlet 58 can be circumferentially offset or circumferentially aligned with the fluid outlet 60. In the illustrated examples, the fluid inlet 58 is circumferentially offset from the fluid outlet 60. In an exemplary embodiment, the fluid 56 is a water-glycol mixture; however, other fluids may be utilized, in various implementations. The fluid 56 that flows within the fluid circuit 26 and, more particularly, the space 18, may be configured to cool various components of the electric drive unit 10 and/or other fluids utilized in the electric drive unit 10, as described further herein.

Referring now to FIGS. 3-6, the at least one rib 20a-20e can be part of a guide system 74 that provides paths in the space 18 along which the fluid 56 can flow. The guide system 74 can include a plurality of ribs 20a-20e that are axially offset from one another forming a plurality of passages 22a-22f respectively disposed between adjacent pairs of the ribs 20a-20e. One or more spines 76 can interconnect the plurality of ribs 20a-20e. For example, a single spine 76 or multiple spines 76 spaced circumferentially from one another around the barrel can be provided. The spine 76 extends axially and can cooperate with the ribs 20a-20e to define the passages 22a-22f. The guide system 74 may enhance heat transfer from the stator 30 to the fluid 56 within the space 18.

The guide system 74 can have a different composition than that of the stator carrier 16. For example, the guide system 74 can be comprised of plastic material. The guide system 74 can be injection-molded plastic and/or printed via three-dimensional printing. Thus, the guide system 74 (e.g., the ribs 20a-20e and/or the spine 76) can be formed separately from the stator carrier 16 and, during manufacturing, be assembled on the barrel 32 of the stator carrier 16. For example, the ribs 20a-20e may not be unitary with the stator carrier 16 in some embodiments. In some examples, the ribs 20a-20e and/or the spine 76 may be formed unitarily with the barrel 32 via, for instance, roll-forming or stamping.

With continued reference to FIGS. 3-6, the electric drive unit 10 includes a first seal 66 and a second seal 68 each configured to generally prevent fluid 56 within the space 18 from undesirably escaping the space 18 between the housing 12 and the stator carrier 16. The first seal 66 can be positioned between the outer wall 14 of the housing 12 and the stator carrier 16 adjacent a rear end 70 of the stator carrier 16. The second seal 68 can be positioned between the housing 12 and the stator carrier 16 adjacent a front end 72 of the stator carrier 16. For example, as illustrated in FIG. 3, each of the first seal 66 and the second seal 68 is disposed between and in contact with a portion of the outer wall 14 that is radially outboard of the first and/or second seal 66, 68 and a portion of the stator carrier 16 that is radially inboard of the first and/or seal 66, 68.

With continued reference to FIGS. 3-6, the space 18 can be radially bounded by an outer surface 78 of the barrel 32 and an inner surface 80 of the housing 12 to define a height of the space 18. The ribs 20a-20e can include raised portions 82 that have a rib height H approaching the height of the space 18. The spine 76 can have a height similar to the rib height 76, thereby limiting flow of the fluid 56 over the spine 76. The raised portions 82 limit axial flow of the fluid 56 between the raised portions 82 and the housing 12. For example, gaps 84 can be defined between the raised portions 82 and the inner surface 80 of the housing 12. The gaps 84 can be minimal to cause the fluid 56 to flow according to the fluid circuit 26 (e.g., through the openings 24a-24z of the ribs 20a-20e and through the passages 22a-22f).

Referring now to FIGS. 3-5, the stator carrier 16 can define a groove 86 that extends radially inwardly into the outer surface 78. The groove 86 can be part of the space 18, and the guide system 74 can be disposed therein. A pair of circumferentially offset ridges 88, 90 can extend annularly from the barrel 32 and further define the groove 86 in which the guide system 74 resides. For example, a first ridge 88 can be disposed adjacent the rear end 70 of the stator carrier 16, and a second ridge 90 can be disposed adjacent the front end 72 of the stator carrier 16. The ridges 88, 90 can provide opposing walls that allow the spine 76 to snap into place within the groove 86 or otherwise be secured and/or aligned therebetween.

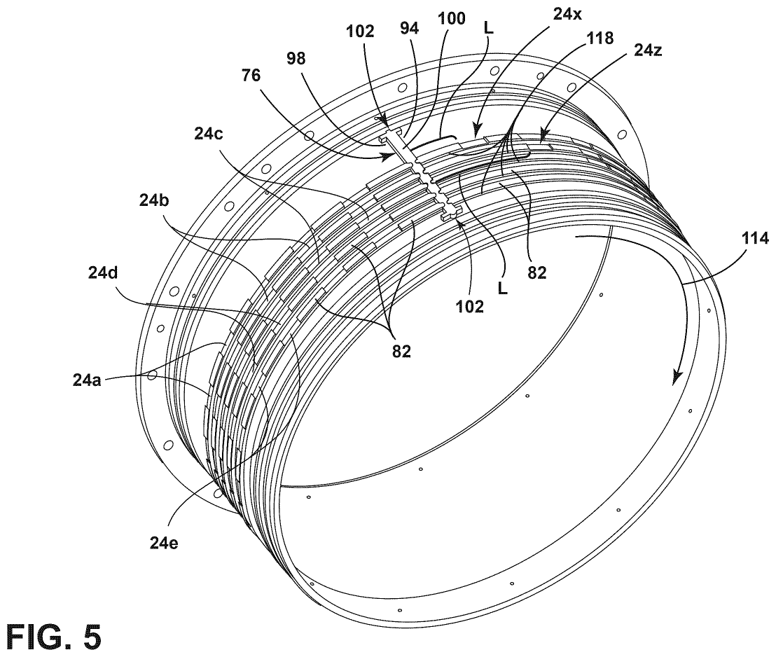

Referring now to FIGS. 5 and 6, the guide system 74 exemplarily includes five ribs 20a-20e and a single spine 76. Each of the ribs 20a-20e includes a body that extends between a first end 92 that couples with the spine 76 on a first side 94 of the spine 76 and a second end 96 that couples with the spine 76 on a second side 98 of the spine 76. For example, each rib 20a-20e can form at least a portion of a circumferential arc around the barrel 32 and couple to at least one spine 76 at both ends 92, 96. The body of each rib includes raised portions 82 circumferentially offset from one another by recessed portions formed by the openings 20a-20e. For example, a first rib 20a can define a first plurality of openings 24a circumferentially interposed by first raised portions 82, a second rib 20b can define a second plurality of openings 24b circumferentially interposed by second raised portions 82, and so on. The axial spacing of the ribs 20a-20e forms the passages 22a-22f, or troughs, that extend circumferentially and axially between a corresponding pair of the ribs 20a-20e. In the present example, six passages 22a-22f are formed. For example, a pair of passages 22a-22b can be spaced from one another by the ribs 20a-20e and any intermediate passages 22c-22f. In the example illustrated in FIGS. 4 and 5, there are four intermediate passages 22c-22f.

The spine 76 can include a frame 100 having an elongated shape and extending in the axial direction to a pair of support ends 102. Each support end 102 can be configured to engage one of the ridges 88, 90 to span the groove 86 and align the guide system 74. Each support end 102 can include a bar 104 extending orthogonally relative to the frame 100 to align the spine 76 in the groove 86. A bump 106 can be provided at each support end 102 for engaging a given one of the ridges 88, 90. In some examples, the support ends 102 can secure and/or maintain alignment on the barrel 32 via another mechanism. For example, at least a portion of the support ends 102 can extend into a trough formed on the barrel 32. In some examples, the spine 76 can maintain axial alignment due to tension of the ribs 20a-20e. Thus, a friction fit in the groove 86 may not be included in some examples, as radially-inward tension can maintain the axial and/or circumferential position of the spine 76.

The circumferential alignment of the spine 76 can cause each rib 20a-20e to maintain axial alignment. For example, frame 100 can form one or more mating connections 108 with each rib 20a-20e, such as a tongue-and-groove connection, a snap-connection or another connection. The mating connections 108 can be axially offset from one another along the frame 100 corresponding to the axial positions of the ribs 20a-20e. In the illustrated example, the mating connection 108 includes a protrusion 110 extending from the rib 20-20e and a receptacle 112 defined by the frame 100, though other fastening mechanisms may be employed to connect the spine 76 with the ribs 20a-20e. While shown as having equal axial spacing, and thus even-sized intermediate passages 22c-22f, it is contemplated that the axial spacing between any given adjacent pair of the ribs 20a-20e can be different from another adjacent pair of the ribs 20a-20e.

With continued reference to FIGS. 5 and 6, the first passage 22a can be formed between the first rib 20a and the first ridge 88, and the second passage 22b can be formed between the last (e.g., fifth) rib 20e and the second ridge 90. The third-sixth passages 22c-22f can be the intermediate passages 22c-22f and be spaced axially between the first passage 22a and the second passage 22b. Accordingly, the first passage 22a can serve as an entry passage for the fluid 56 into the space 18 due to the fluid inlet 58 being adjacent with the first passage 22a. Similarly, the second passage 22b can serve as an exit passage for the fluid 56 out of the space 18 due to the fluid outlet 60 being adjacent the second passage 22b.

As shown in FIGS. 5 and 6, the pattern of openings on the ribs 20a-20e can differ rib-to-rib. For example, the pattern of openings 24a-24z can be based on the relative axial positions of the ribs 20a-20e. In the present example, the rib 20a nearest the first passage 22a defines a first opening 24x of the first plurality of openings 24a that is a nearest opening of the first plurality of openings 24a to the spine 76 in a first circumferential direction 114. This nearest first opening 24x can be circumferentially spaced from a nearest second opening 24z of the second plurality of openings 24b to the spine 76 in the first circumferential direction 114. Each sequential “nearest opening” to the spine 76 in the first circumferential direction 114 formed on the third-fifth ribs 20c-20e can be spaced further from the spine 76 in the first circumferential direction 114, as illustrated. As shown, the “furthest” opening of each plurality of openings 24a-24e from the spine 76 in the first circumferential direction 114 (or “nearest” opening in a second opposing circumferential direction) are equidistant from the spine 76. For example, each plurality of openings 24a-24e can have the same circumferential spacing (e.g., a same length of the raised portions 82) following the nearest opening (e.g., 24x, 24z) in the first circumferential direction 114.

With continued reference to FIGS. 5 and 6, the first opening 24x can be circumferentially offset from the second opening 24z. The first opening 24x can be nearer to the spine 76 than the second opening 24z is to the spine 76. The second opening 24z can be aligned with one of the first plurality of openings 24a nearest to the first opening 24x in the first circumferential direction 114. The relationship of the openings of any adjacent pair of ribs 20a-20e can follow this same pattern, such that all but one of the first plurality of openings 24a of a first rib of the pair of adjacent ribs 20a, 20b are respectively aligned with all of the second plurality of openings 24b of a second rib 20b of the pair of adjacent ribs 20a, 20b. In some examples, the length of the raised portions 82 for a rib can vary along the first circumferential direction 114 following the nearest opening (e.g., 24x, 24z, etc.).

In the present example, each rib 20a-20e includes a leading raised portion 118 that extends from the spine 76 in the first circumferential direction 114. For example, the leading raised portion 118 can include a protrusion 110 that is received by the spine 76 via one of the mating connections 108 (e.g., a receptacle 112) at the first end 92 of the leading raised portion 118. The first rib 20a has a first leading raised portion 118, the second rib 20b has a second leading raised portion 118, and so on. While a remainder of the raised portions 82 of the second rib 20b can have the same lengths, the second leading raised portion 118 can extend further from the spine 76 than the first leading raised portion 118 extends from the spine 76, the third leading raised portion 118 can extend further from the spine 76 than the second leading raised portion 118 extends from the spine 76, and so on. Thus, a leading length L of the first rib 20a can differ from a leading length L of the second rib 20b, and so on. For example, the first opening 24x can circumferentially align with the second leading raised portion 118, the second opening 24z can circumferentially align with the third leading raised portion 118, and so on. The cascading pattern of openings 24x, 24z (e.g., via the increasing lengths of the leading raised portions 118) may facilitate a distribution of the fluid 56 to provide enhanced thermal management of the electric drive unit 10.

The openings 24a-24z can include any void that allows fluid 56 to flow from one passage 22a-22f to the next. For example, the openings 24a-24z can include through-holes, notches, or indentation in the ribs 20a-20e that provide fluid communication therethrough. Thus, while shown as recessed portions, it is contemplated that the openings 24a-24z may be covered, such that the opening is a hole that extends axially through a width of the rib 20a-20e without resulting in the recessed portions.

Referring now to FIG. 6, flow paths are demonstrated with fluid 56 flowing in the first circumferential direction 114. As shown, in operation of an exemplary embodiment of the electric drive unit 10, fluid 56 is conveyed into the first passage 22a of the space 18 via the fluid inlet 58. Heat from the stator 30 is transferred through the stator carrier 16 and into the fluid 56 that is flowing through the space 18, such that the stator 30 is cooled. The fluid 56 can flow in a cascading or sequential manner in the axial direction. For example, the fluid circuit 26 can form several paths between the first passage 22a and the second passage 22b. In operation, when fluid 56, such as coolant, is provided in the space 18 via the fluid inlet 58, the fluid 56 enters the first passage 22a. Some fluid 56 will flow through the first opening 24x and into the third passage 22c, and some fluid 56 will flow circumferentially within the first passage 22a until dispersing into the third passage 22c via the next adjacent one of the plurality of first openings 24a, and so on. Fluid 56 that flows into the third passage 22c can then continue to flow circumferentially in the third passage 22c or flow through the second opening 24z into the fourth passage 22d, and so on. As shown in FIG. 6, each path of the fluid 56 can lead to the second passage 22b. It is contemplated that the pattern can provide an increasing number of possible paths to the second passage 22b as the fluid 56 moves in the first circumferential direction 114.

The electric drive unit 10 of the present disclosure may provide a variety of advantages. First, the guide system 74 can provide a modular solution to limit complicated forming, stamping, or sand casting manufacturing methods to provide guides for the fluid 56. The pattern of the guide system 74 can also provide for enhanced thermal management by controlling the height and distribution of openings on the ribs 20a-20e to extract heat at targeted locations. Thus, the fluid jacket 18 can provide for thermal efficiency while also providing a simple manufacturing/assembly process. The guide system 74 may provide for ease of assembly.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 electric drive unit
12 housing
14 outer wall
16 stator carrier
18 space/fluid jacket
20a-20e ribs
22a-22f passages
24a-z openings
26 fluid circuit
28 bearing shield
30 stator
32 barrel
34 motor housing region
36 gearbox region
38 motor
40 central aperture
42 axis
44 rotor shaft
46 bearing
48 dynamic seal
50 first surface
52 second surface
54 rotor
56 fluid
58 fluid inlet
60 fluid outlet
62 first axial position
64 second axial position
66 first seal
68 second seal
70 rear end
72 front end
74 guide system
76 spine
78 outer surface
80 inner surface
H rib height
82 raised portion
84 gaps
86 groove
88 first ridge
90 second ridge
92 first end
94 first side
96 second end
98 second side
100 frame
102 support ends
104 bar
106 bump
108 mating connection
110 protrusion
112 receptacle
114 first circumferential direction
118 leading raised portion
L leading length

What is claimed is:

1. An electric drive unit comprising:
a housing that includes an outer wall;
a stator carrier disposed radially inboard of the outer wall defining a space therebetween; and
at least one rib contacting the stator carrier and forming a pair of passages, wherein the at least one rib defines at least one opening forming a path between the pair of passages.

2. The electric drive unit of claim 1, wherein the at least one opening includes a plurality of openings, each forming a recessed portion of the at least one rib, wherein the recessed portions of the at least one rib are spaced apart by raised portions of the at least one rib that extend radially outboard relative to the recessed portions.

3. The electric drive unit of claim 2, wherein the at least one rib includes a first rib and a second rib axially spaced from the first rib to form an intermediate passage therebetween.

4. The electric drive unit of claim 3, wherein a recessed portion of the first rib is circumferentially aligned with a first raised portion of the second rib.

5. The electric drive unit of claim 4, comprising:
a spine coupled with the first rib and the second rib and extending axially in the space to further define the pair of passages and the intermediate passage.

6. The electric drive unit of claim 5, wherein each of the first rib and the second rib includes a body extending between a first end coupled with the spine and a second end coupled with the spine.

7. The electric drive unit of claim 6, wherein the first rib includes a second raised portion extending from the first end of the first rib, and wherein the first raised portion extends from the first end of the second rib further than the second raised portion extends from the first end of the first rib.

8. The electric drive unit of claim 1, comprising:
a spine contacting the stator carrier and coupled to the at least one rib, wherein the at least one rib includes a first rib and a second rib axially spaced from the first rib, the at least one opening includes one or more first openings defined by the first rib, the one or more first openings comprises a first opening that is a nearest one of the one or more first openings to the spine in a first circumferential direction, the at least one opening includes one or more second openings defined by the second rib, the one or more second openings comprises a second opening that is a nearest one of the one or more second openings to the spine in the first circumferential direction, and the first opening is circumferentially offset from the second opening.

9. The electric drive unit of claim 1, wherein the stator carrier defines a circumferential groove extending radially inwardly in which the at least one rib is disposed.

10. The electric drive unit of claim 1, comprising:
a fluid inlet that conveys fluid into a first passage of the pair of passages; and
a fluid outlet that conveys fluid out of a second passage of the pair of passages.

11. The electric drive unit of claim 1, wherein the at least one rib is not unitary with the stator carrier.

12. An electric drive unit comprising:
a housing that includes an outer wall;
a stator carrier disposed radially inboard of the outer wall defining a space therebetween;
a first rib contacting the stator carrier and extending circumferentially therearound, the first rib including a first raised portion and defining a first opening and a second opening spaced circumferentially from the first opening by the first raised portion; and
a second rib contacting the stator carrier and extending circumferentially therearound, the second rib axially spaced from the first rib to define a passage therebetween, wherein the second rib includes a second raised portion and defines a third opening at least partially formed by the second raised portion, and wherein the first opening is circumferentially aligned with the second raised portion and the second opening is circumferentially aligned with the third opening.

13. The electric drive unit of claim 12, comprising:
a spine coupled with the first rib and the second rib and extending axially in the space to further define the passage.

14. The electric drive unit of claim 13, wherein each of the first rib and the second rib includes a body extending between a first end coupled with the spine and a second end coupled with the spine.

15. The electric drive unit of claim 12, wherein the stator carrier defines a circumferential groove in which the first rib and the second rib are disposed.

16. The electric drive unit of claim 13, wherein the spine is configured to circumferentially retain the ribs relative to the stator carrier.

17. The electric drive unit of claim 13, wherein the spine is configured to axially retain the ribs relative to the stator carrier.

18. An electric drive unit comprising:
a housing that includes an outer wall;
a stator carrier disposed radially inboard of the outer wall defining a space therebetween;
a spine extending axially in the space;
a first rib that extends from the spine and that defines a first plurality of openings that are circumferentially offset from each other, the first plurality of openings including a first opening that is a nearest opening of the first plurality of openings to the spine in a first circumferential direction;
a second rib that extends from the spine and that defines a second plurality of openings that are circumferentially offset from each other, the second plurality of openings including a second opening that is a nearest opening of the second plurality of openings to the spine in the first circumferential direction; and
wherein the first opening is circumferentially offset from the second opening, the first opening is nearer to the spine than the second opening is to the spine, and the second opening is aligned with one of the first plurality of openings nearest to the first opening in the first circumferential direction.

19. The electric drive unit of claim 18, wherein the second opening is circumferentially aligned with the one opening of the first plurality of openings nearest to the first opening in the first circumferential direction.

20. The electric drive unit of claim 18, wherein the first plurality of openings includes all of the openings defined by the first rib, and the second plurality of openings includes all of the openings defined by the second rib.
